(19) United States
(12) Patent Application Publication
(10) Pub. No.: US 2025/0369491 A1
(43) Pub. Date: Dec. 4, 2025

(54) VEHICLE DISC BRAKE APPARATUS

(71) Applicant: HL MANDO CORPORATION, Pyeongtaek-si (KR)

(72) Inventor: Satish Ramchandra Kolekar, Farmington, MI (US)

(21) Appl. No.: 18/678,697

(22) Filed: May 30, 2024

(51) Int. Cl. F16D 65/00

(52) U.S. Cl. CPC F16D 65/0087; F16D 65/0068

(57) ABSTRACT

The present disclosure is directed to a vehicle disc brake apparatus. The vehicle disc brake apparatus includes a caliper body, a brake pad carrier coupled to the caliper, a guide rod extending between the caliper and the brake pad carrier, and a bias spring surrounding the guide rod with a first end of the bias spring coupled to the caliper and a second opposing end of the bias spring coupled to the brake pad carrier. The bias spring is configured to generate a return force between the brake pad carrier and the caliper upon a brake release. Related brake housing apparatuses and bias springs are disclosed herein.

### FIELD OF THE INVENTION

The present invention relates generally to vehicle brakes, and more particularly, to vehicle disc brakes.

### BACKGROUND

A vehicle disc brake system, such as a floating-type caliper brake system 10 illustrated in FIGS. 1A-1C, includes a brake disc 15 (also called a rotor) that is connected to a vehicle wheel, a caliper 22, a (brake pad) carrier 24, and two or more brake pads, such as an inner or inboard brake pad 32 and an outer or outboard brake pad 34 on opposing sides of the rotor 15. The brake pads 32, 34 are mounted within the carrier 24 so that the brake pads 32, 34 can move axially, along a rotor axis, a piston bore axis, or both, toward and away from the rotor 15.

For example, as illustrated in FIG. 1B, when a vehicle brake is applied by an operator of the vehicle, hydraulic fluid flows into the caliper 22 via conduit C and forces a piston (not shown) outward. This outward movement of the piston forces the inner brake pad 32 into contact with the inboard surface of the rotor 15, and also creates a rearward force that causes the caliper 22 to move axially along the guide rods 26 relative to the carrier 24 (as indicated by arrow BA in FIG. 1B) which forces the outer brake pad 34 against the opposing outboard surface of the rotor 15. Pressing the brake pads 32, 34 against the rotor 15 causes braking of the wheel. When the brake pedal is released, the hydraulic fluid flows out of the caliper 22, thereby allowing the piston to retract and release the inner brake pad 32 from contacting the rotor 15. As the piston retracts, the caliper 22 moves in the opposite direction along the guide rods 26 and relative to the carrier 24 (as indicated by arrow BR in FIG. 1C) which pulls the outer brake pad 34 away from the rotor 15, thereby allowing the rotor 15 to rotate relative to caliper 22.

There is an ongoing need to reduce residual brake drag in disc brake systems caused by unwanted contact between brake pads and a rotor in non-braking conditions. In the current market, in which manufacturers are moving towards electrification, battery life is a major focus point. In electric vehicles, drag caused by brake pads contacting a rotor when braking is not needed may reduce battery life. For example, it has been estimated that battery life may be reduced by about 0.5 mile per 1 Nm drag per disc brake caliper.

In current floating-type caliper designs, one or more springs may be utilized to assist in retracting an outer brake pad away from a rotor when the brakes are released. However, the spring retraction force may be insufficient to move the carrier and caliper away from each other such that the outer brake pad is completely retracted from the rotor. For example, when the spring retraction force is less than the sliding friction force between the rotor and the brake pads, brake drag may occur because of unwanted contact even in non-braking conditions. As such, some brake pad drag may still occur.

Summary

As a first aspect, embodiments of the invention are directed to a vehicle disc brake apparatus. The vehicle disc brake apparatus includes a caliper, a brake pad carrier coupled to the caliper, a guide rod extending between the caliper and the brake pad carrier, and a bias spring surrounding the guide rod with a first end of the bias spring coupled to the caliper and a second opposing end of the bias spring coupled to the brake pad carrier. The bias spring is configured to generate a return force between the brake pad carrier and the caliper upon a brake release.

As a second aspect, embodiments of the invention are directed to a vehicle disc brake apparatus. The vehicle disc brake apparatus includes a housing, a carrier, a guide rod extending between the carrier and the housing, a retention member provided on the carrier, and a bias spring surrounding the guide rod with a first end of the bias spring coupled to the retention member and a second opposing end of the bias spring engaged with the housing. The bias spring is configured to generate a return force between the carrier and the housing upon a brake release.

As a third aspect, embodiments of the invention are directed to bias spring for a brake assembly. The bias spring has a spring body with a first U-shaped section, a second U-shaped section, and an intermediate arcuate section connecting the first and section sections. The first U-shaped section of the bias spring is configured to engage a caliper body of the brake assembly. The second U-shaped section of the bias spring is configured to engage a brake pad carrier of the brake assembly. The intermediate section extends circumferentially around a guided rod coupled between the caliper body and the brake pad carrier of the brake assembly and is configured to be extended in an axial direction upon a brake action and to return to an unextended state upon a brake release, thereby generating a return force between the caliper body and the brake pad carrier.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1A is a perspective view of a conventional brake assembly.

FIG. 1B is a top perspective view of the conventional brake assembly of FIG. 1A illustrating movement of the caliper body relative to the carrier when a brake action is applied.

FIG. 1C is a top perspective view of the conventional brake assembly of FIG. 1A illustrating movement of the caliper body relative to the brake pad carrier when a brake action is released.

FIG. 2 is a top perspective view of a vehicle disc brake apparatus according to embodiments of the present invention.

FIG. 3 is a top perspective view of the vehicle disc brake apparatus of FIG. 2 with the caliper body removed.

FIG. 4A is a top view of the vehicle disc brake apparatus of FIG. 2.

FIG. 4B is another top view of the vehicle disc brake apparatus of FIG. 2.

FIG. 5 is a side view of the vehicle disc brake apparatus of FIG. 2.

FIG. 6 is a side view of the vehicle disc brake apparatus of FIG. 2 illustrating relative movement of the caliper body when the brake is applied and released according to embodiments of the present invention.

FIG. 7 is an enlarged perspective view of a bias spring for the vehicle disc brake apparatus according to embodiments of the present invention.

FIG. 8 is a perspective view of the bias spring of FIG. 7 according to embodiments of the present invention.

FIG. 9A is a perspective view of the carrier with the retention member schematically illustrating different attachment locations for the bias spring according to embodiments of the present invention.

FIG. 9B is an enlarged view of the retention member shown in FIG. 9A.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout and different embodiments of like elements can be designated using a different number of superscript indicator apostrophes (e.g., 10′, 10″, 10″′).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

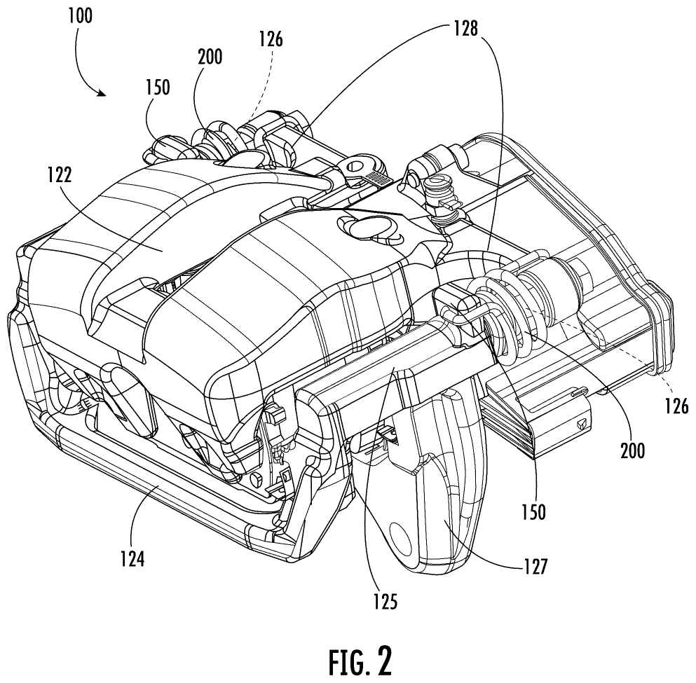

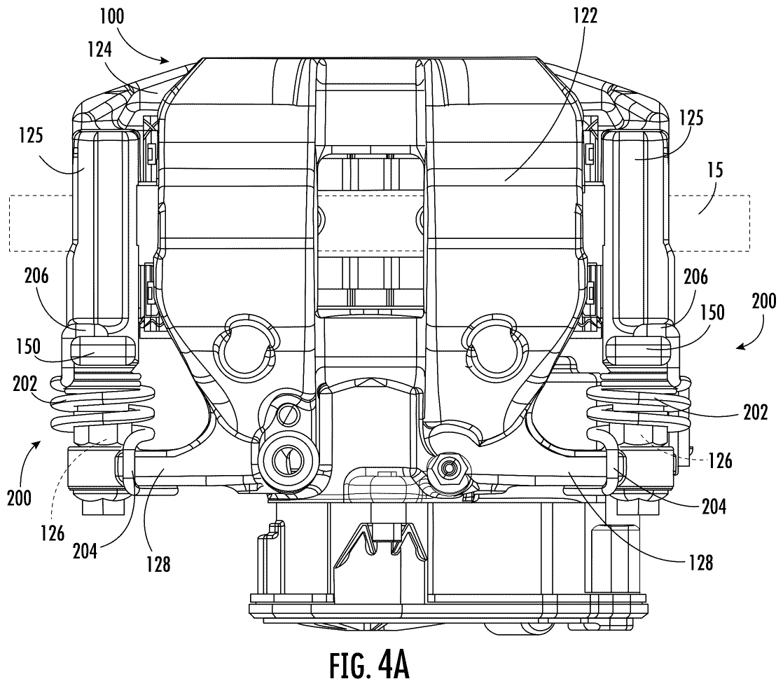

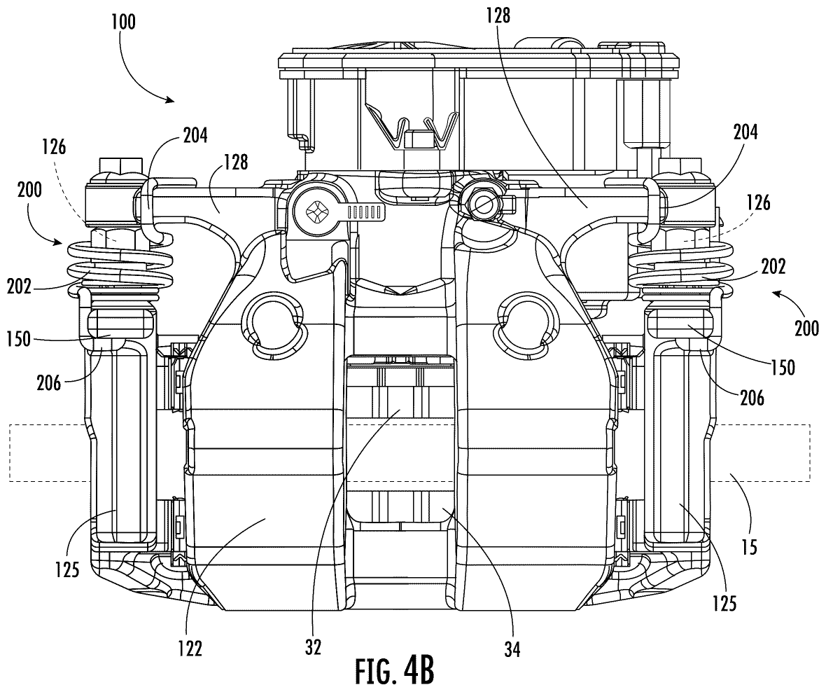

Pursuant to embodiments of the present invention, a vehicle disc brake apparatus is provided that is configured to help decrease or eliminate brake drag contributed from the outer brake pad within the assembly, thereby increasing pad friction life. The vehicle disc brake apparatus of the present invention may help to improve return performance of the outer brake pad. In addition, the overall performance of the apparatus may be improved compared to current brake housing assemblies. Embodiments of the present invention will now be discussed in greater detail with reference to FIGS. 2-9B.

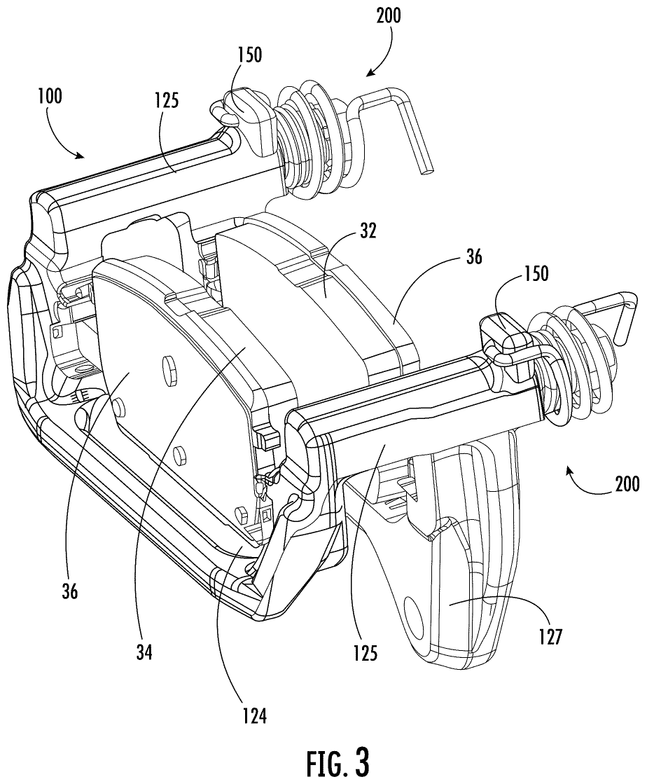

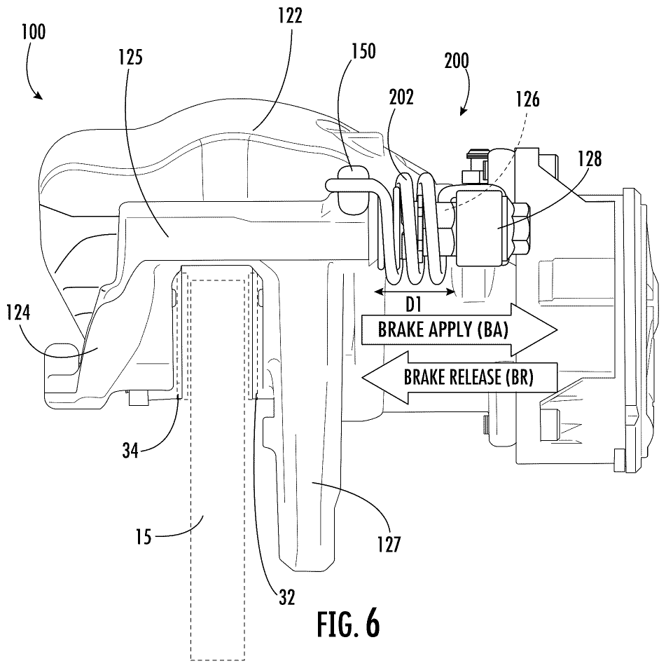

FIGS. 2-6 illustrate a vehicle disc brake apparatus 100 according to embodiments of the present invention, which can be used to create braking force, e.g., for braking a vehicle. Generally, as shown in FIGS. 2-6, the vehicle disc brake apparatus 100 includes a caliper body (or housing) 122 and brake pad carrier 124. The caliper body 122 is movably coupled to the brake pad carrier 124 via a pair of guide rods (or slider pins) 126. In some embodiments, a section 127 of the brake pad carrier 124 is affixed, for example, to part of the vehicle axle, which allows the caliper body 122 to move relative to the brake pad carrier 124 during a braking action, as described in further detail below. The vehicle disc brake apparatus 100 of the present invention also includes a pair of brake pads 32, 34 supported by the brake pad carrier 124 and that are spaced apart from each other such that a rotor 15 associated with a vehicle wheel (not shown) can be positioned therebetween. The caliper body 122 and/or brake pad carrier 124 may function to support the brake pads 32, 34, for example, via brackets 36, within a brake system (see, e.g., FIG. 3), house one or more pistons (not shown), axially move the brake pads 32, 34 (see, e.g., FIG. 6), assist in creating the braking action, or a combination thereof.

The caliper body 122 houses a piston (not shown) that is configured to advance and retreat in response to braking hydraulic pressure, and the like. The vehicle disc brake apparatus 100 performs braking of a vehicle wheel as the piston presses the inner brake pad 32 against the rotor 15 and the caliper body 122 slides from the brake pad carrier 124 by a reaction force against the pressing to press the outer brake pad 34 toward the rotor 15.

As further shown in FIGS. 2-8, according to embodiments of the present invention, at least one biasing member 200 is provided in the vehicle disc brake apparatus 100 for moving the caliper body 122 and corresponding outer brake pad(s) 34 relative to the brake pad carrier 124 after a brake release. For example, in some embodiments, the biasing member 200 is a spring. In some embodiments, the bias spring 200 is a tension spring. As described in further detail below, the movement of the caliper body 122 and brake pad carrier 124 relative to each other during braking causes each guide rod 126 to move to an extended position which causes each biasing member 200 to be longitudinally stretched to an extended position from a contracted/relaxed position. When a force causing the at least one biasing member 200 to become extended or stretched (e.g., during a braking operation) is removed (e.g., when a braking operation is over), the at least one biasing member 200 is configured to return to a relaxed configuration at least partially as a result of a spring force of the at least one biasing member 200. In some embodiments, the biasing member 200 may comprise more than one spring (e.g., an upper spring and a lower spring). In some embodiments, multiple biasing members 200, serially or parallelly connected to each other, may be used. In some embodiments, the biasing member 200 may comprise a solid biasing member. In some embodiments, the biasing members 200 may have collapsible shape, for example, an accordion-like tube. The biasing members 200 may be referred to as bias springs 200.

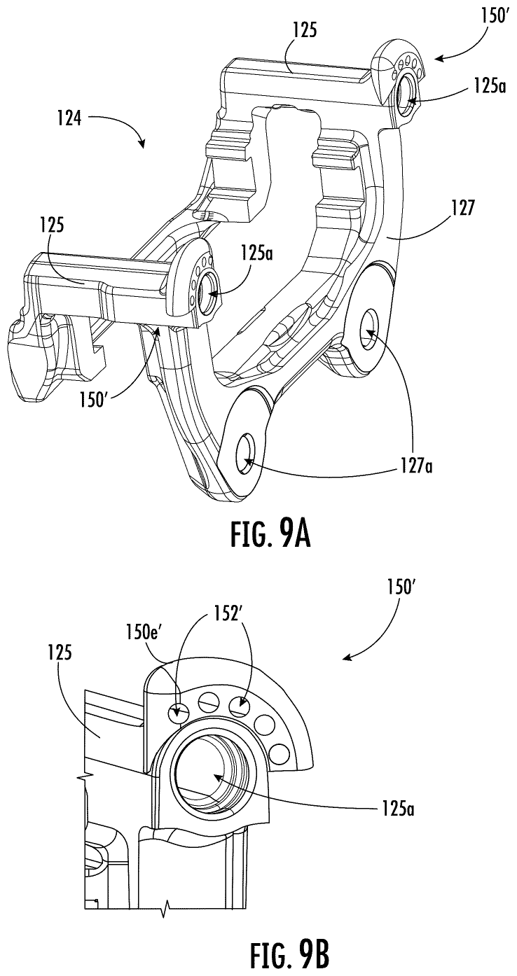

In the embodiment shown, the vehicle disc brake apparatus 100 includes two bias springs 200, each bias spring 200 engaging a respective arm 125 of the brake pad carrier 124 at one end and engaging a segment of the caliper body 122 (or housing ear 128) at the opposing end. Each of the bias spring 200 may encircle a respective guide rod 126; the guide rods 126 couple each arm 125 of the brake pad carrier 124 to a respective housing ear 128 of the caliper body 122. In some embodiments, the guide rod 126 resides within a channel 125a extending in the arm 125 of the brake pad carrier 124 (see, e.g., FIGS. 9A-9B). In other words, at least a portion of each of the bias springs 200 may extend circumferentially around (i.e., wrapped or coiled around) each guide rod 126 and be coupled to the caliper body 122 and brake pad carrier 124 of the vehicle disc brake apparatus 100 at opposing ends.

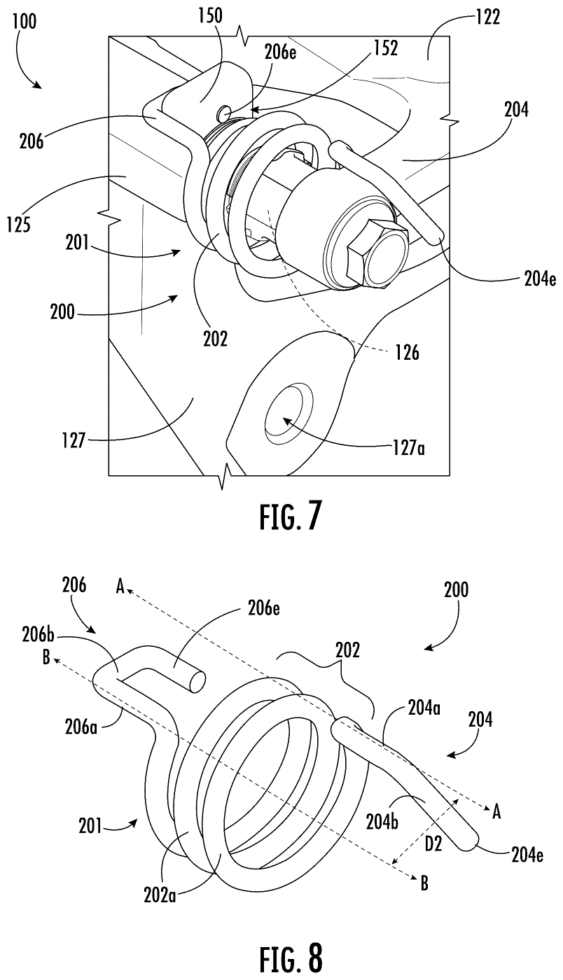

In some embodiments, each arm 125 of the brake pad carrier 124 may comprise a retention member or bracket 150 coupled thereto (see also, e.g., FIGS. 9A-9B). Each retention member 150 may be configured to engage an end (e.g., end 206e) of a respective bias spring 200. In some embodiments, the retention member 150 helps to prevent dislocation of the bias spring 200 and aligns the bias spring 200 with the respective guide rod 126. In the depicted embodiment, the bias springs 200 and the retention members 150 are separate pieces. In some embodiments, the retention members 150 may be fixed (i.e., not movable) relative to the brake pad carrier 124 (e.g., the arm 125) while the bias springs 200 are movably disposed (e.g., slidable) relative to brake pad carrier 124 (and the guide rods 126). In some embodiments, the bias spring 200 may be configured to have an inline attachment with the retention member 150 to have smooth movement of the guide rods 126 within the carrier body 122. The retention member 150 may be disposed at any location of the brake pad carrier 124 relative to the guide rods 126. For example, in some embodiments, the retention member 150 may be disposed on an upper surface of the brake pad carrier 124 (e.g., the arm 125) (see, e.g., FIG. 7). In other embodiments, the retention member 150 may be disposed on a side surface of the brake pad carrier 124 (e.g., the arm 125). In other embodiments, the retention member 150 may be disposed on a lower surface of the brake pad carrier 124 (e.g., the arm 125). In some embodiments, the retention members 150 may be integrally formed with the brake pad carrier 124 (e.g., the arm 125). In alternative embodiments, the retention member 150 and the bias spring 200 may form one piece, and can be moveable, for example, relative to the brake pad carrier 124. However, embodiments of the present inventive concept are not limited to the illustrated ways the bias spring 200 is secured to each housing ear 128 of the caliper body 122 and the brake pad carrier 124 (e.g., the arm 125). Various ways of securing each bias spring 200 to the caliper body 122 and the brake pad carrier 124 may be utilized, as would be understood by one of skill in the art of the present inventive concept.

In the present disclosure, the axial direction is defined by the axial movement of the inner and outer brake pads 32, 34 toward each other during a brake action and away from each other during a brake release action. The lateral direction may be perpendicular to the axial direction. The axial direction and the lateral direction may both lie in a horizontal plane.

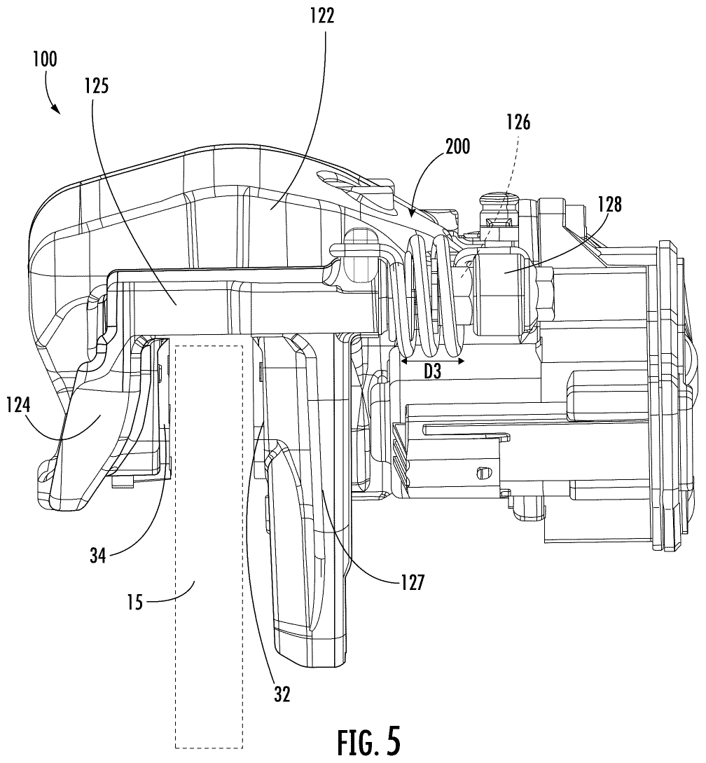

During braking, each guide rod 126 moves together with the caliper body 122 in the direction BA (FIG. 6) which causes each bias spring 200 to move to an extended position. In some embodiments, each bias spring 200 is configured to pull or force the caliper body 122 (and corresponding outer brake pads 34) a distance D1 in a first axial direction (i.e., toward the rotor 15) upon a brake being applied (e.g., as indicated by arrow BA in FIG. 6). The extension of each bias spring 200 creates a force on the respective bias spring 200 such that, when braking is released, a reaction spring force is applied by the bias springs 200 waiting to return to its relaxed or contracted state in the direction BR (FIG. 6). This reaction spring force is applied to each guide rod 126 and to the caliper body 122, which moves the brake pads 32, 34 away from the rotor 15 when a braking operation is over. In other words, each bias spring 200 is configured to push or force the caliper body 122 (and corresponding outer brake pads 34) a distance D3 (see, e.g., FIG. 5) in a second opposing axial direction (i.e., away from the rotor 15) upon a brake release BR (e.g., as indicated by arrow BR in FIG. 6). The bias springs 200 are configured to exert an additional axial force outwardly, relative to the rotor 15, to further push or retract the outer brake pads 34 away from the rotor 15 after the braking release has been performed. The biasing member or spring 200 provides a return force that brings the brake pad carrier 124 and caliper body 122 closer together upon a brake release, allowing the brake pads 32, 34 to separate from the rotor 15. Thus, the bias spring 200 assists in further retracting the outer brake pad(s) 34 after the brake has been released to avoid contact between the outer brake pad 34 and the rotor 15.

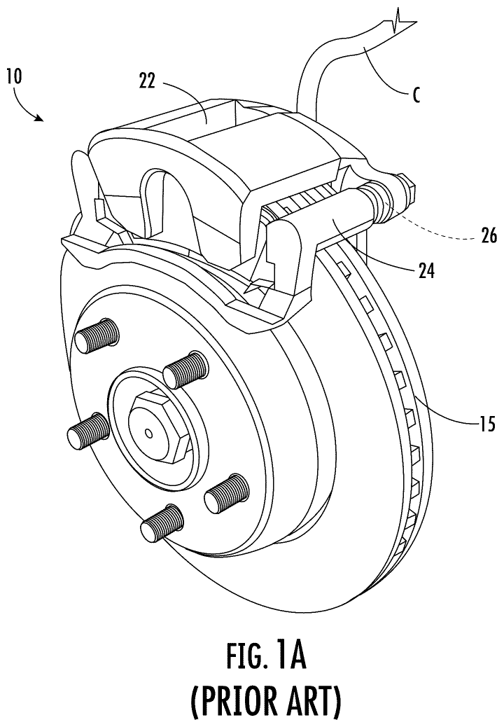

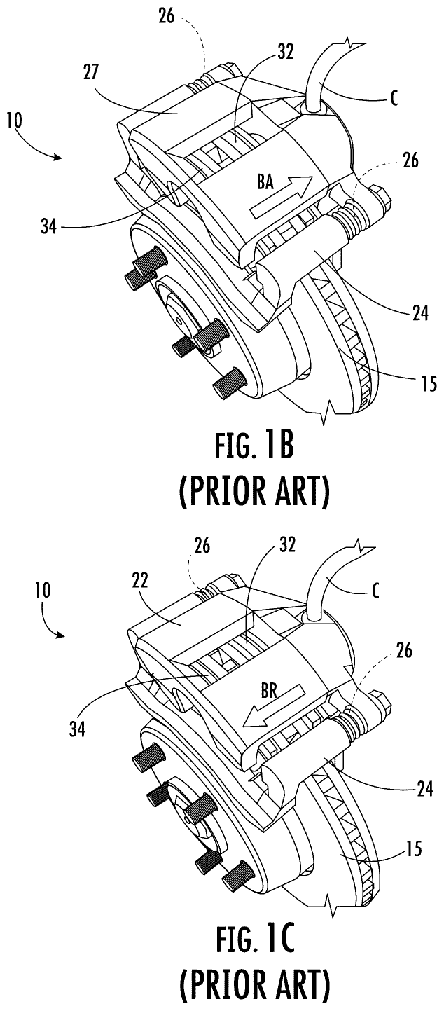

For example, when a vehicle operator presses a brake pedal within the vehicle, hydraulic fluid is caused to flow into the caliper body 122 and push a piston (not shown), which pushes an inner brake pad 32 into contact with a surface of a rotor (e.g., the rotor 15 in FIGS. 1A-1C). This braking operation causes the caliper body 122 and each guide rod 126 to move, which causes each biasing member 200 to longitudinally expand (i.e., stretch or extend) creating a spring force in each biasing member 200. This spring force is imparted to each guide rod 126 because each biasing member 200 is attached to a respective guide rod 126 (e.g., via a housing ear 128), which causes the caliper body 122 to move away from the rotor 15 when a braking operation is over. In other words, because each guide rod 126 is secured to the caliper body 122, as the caliper body 122 moves during braking, the guide rod 126 is moved (i.e., in direction BA, see FIG. 6). This movement causes each biasing member 200 to longitudinally expand, thereby creating a spring force. Upon the removal of the braking force, the biasing member 200 associated with each guide rod 126 is returned to a contracted state, which urges movement of the guide rod 126 (i.e., in the direction BR, see FIG. 6). Thus, a biasing member 200 for a caliper brake, according to embodiments of the present inventive concept, and a caliper brake including the same, can substantially reduce or eliminate a brake pad drag phenomenon by generating a reaction force in the biasing member 200 during braking to move the caliper body 122 to its original position prior to braking, thereby moving the brake pads 32, 34 away from the rotor 15 when a braking operation is ended.

A more detailed representation of one of the bias springs 200 is shown in FIG. 7 and FIG. 8. The bias spring 200 may be formed from spring steel or other similar material. In some embodiments, the bias spring 200 may be clad with an elastomeric material, such as EPDM. Different bias springs 200 may be used based on the caliper braking system. In some embodiments, each bias spring 200 has a spring body 201 with undulations or coils including a housing section 204, a bracket section 206 and an intermediate section 202. The intermediate section 202 connects the housing and bracket sections 204, 206. The undulations or coils in the spring body 201 cause the bias spring 200 to act like a spring under tension when stretched such that, when a force causing the bias spring 200 to become extended or stretched (e.g., during a braking operation) is removed (e.g., when a braking operation is over), the bias spring 200 is configured to return to a relaxed configuration as a result of spring force. As shown in FIG. 7, in some embodiments, the intermediate section 202 has a plurality of coils 202a that extend circumferentially (or wrap) around the guide rod 126 (i.e., the intermediate section 202 is wrapped around at least a portion of the guide rod 126). It is noted that the intermediate section 202 of the bias spring 200 may have a more or less coils 202a than what is shown in FIG. 8. In some embodiments, the housing section 204 of the bias spring 200 is bent to engage a segment of the caliper body 122 (or housing ear 128). For example, as shown in FIG. 8, in some embodiments, the housing section 204 of the bias spring 200 has an axial extending section 204a and a lateral extending section 204b. In some embodiments, the housing section 204 of the bias spring 200 may be generally U-shaped. In some embodiments, as shown in FIGS. 7 and 8, in some embodiments, an end 204e of the housing section 204 may extend in a lateral direction that is generally orthogonal to the intermediate section 202 (and the housing ear 128).

In some embodiments, the bracket section 206 of the bias spring 200 is coupled to the brake pad carrier 124 (e.g., the arm 125). For example, in some embodiments, the bracket section 206 of the bias spring 200 is configured to engage the retention member 150 which is secured to a respective arm 125 of the brake pad carrier 124. Similar to the housing section 204 of the bias spring 200, as shown in FIG. 7, in some embodiments, the bracket section 206 of the bias spring 200 may be bent to engage the retention member 150. For example, as shown in FIG. 8, in some embodiments, the bracket section 206 of the bias spring 200 has an axially extending section 206a and a laterally extending section 206b which is configured to engage the retention member 150 (see also, e.g., FIG. 7). In some embodiments, the bracket section 206 of the bias spring 200 may be U-shaped.

Biasing members 200 for caliper brakes, as described herein, can substantially reduce or eliminate a brake pad drag phenomenon by generating a reaction force of the biasing member 200 during braking to move a caliper body 122 to its original position prior to braking, thereby moving the brake pads 32, 34 away from the rotor 15 when a braking operation is ended. These biasing members 200 improve outboard pad assembly return performance and decrease drag amount contribution from the outer brake pad assembly. Moreover, overall performance of a caliper brake can be improved in addition to increasing brake pad life.

As shown in FIG. 7, in some embodiments, the retention member 150 may have one or more apertures 152 configured to receive an end 206e of the bracket section 206 of the bias spring 200, thereby securing the bias spring 200 to the retention member 150 and the corresponding brake pad carrier 124 (e.g., the corresponding arm 125). While the retention member 150 may include more than one aperture 152, only one of the apertures 152 may be used to connect the bias spring 200. In addition, the connecting locations on the retention member 150 and sizes of the respective apertures 152 may be changed depending on the specific biasing member 200 (see, e.g., FIGS. 9A-9B).

It is noted that the bias spring 200 may be attached or secured to the retention member 150 in other ways. For example, in some embodiments, the retention member 150 may have an annular recess or slot that receives the bracket section 206 of the bias spring 200, thereby securing the bias spring 200 to the retention member 150. In other embodiments, the bias spring 200 may be secured or couped directly to the brake pad carrier 124 (e.g., the arm 125). For example, in some embodiments, the bracket section 206 of the bias spring 200 may be bent to engage the brake pad carrier 124 (i.e., in a similar manner to how the housing section 204 of the bias spring 200 is bent to engage the housing ear 128 or caliper body 122).

As shown in FIG. 7, in some embodiments, the retention member 150 may have a generally rectangular or rounded rectangle shape. However, in other embodiments, the retention member 150 may have a different shape. For example, as shown in FIGS. 9A-9B, in some embodiments, the retention member 150′ may have an arcuate outer edge 150e′. The plurality of apertures 152′ in the retention member 150′ shown in FIGS. 9A-9B schematically illustrate that the aperture 152′ may be provided in a number of different locations on the retention member 150′ to secure an end 206e of the bias spring 200.

Referring back to FIG. 8, the axial extending section 204a of the housing section 204 of the bias spring 200 may extend along a first axis A and an axial extending section 206a of the bracket section 206 of the bias spring 200 may extend along a second axis B. In some embodiments, the first axis A and the second axis B are spaced apart a distance D2 and extend substantially parallel to each other. In some embodiments, the distance D2 between the first and second axis A, B is as close to zero and/or as close to parallel as possible to help prevent the bias spring 200 from slipping off (or disengaging from) the caliper body 122 (i.e., the housing ear 128) and/or from “arching” away from the axial direction during movement.

In the following, the mode of operation of the bias spring 200 is explained. When a braking action is initiated, the brake pads 32, 34 are moved towards the rotor 15 (see also, e.g., FIG. 1C). During braking, as shown in FIG. 6, the bias spring 200, i.e., the intermediate section 202, is extended in a first axial direction (as indicated by arrow BA). After the braking action has been performed and the brake is released, the brake pads 32, 34 move away from the rotor 15 (see also, e.g., FIG. 1B). According to embodiments of the present invention, the bias spring 200 is configured to assist in retracting the outer brake pad 34 away from the rotor 15 by providing a retraction force in a second, opposite axial direction that pulls the caliper body 122 (via the retention member 150 and brake pad carrier 124) outwardly creating space between the outer brake pad 34 and the rotor 15. Thus, the retraction force provided by the bias spring 200 is enough to overcome the force of brake pad carrier 124 on the caliper body 122 (e.g., sliding friction force between the outer brake pad 34 and the rotor 15), thereby creating space between the corresponding outer brake pad 34 and the rotor 15.

Thus, by virtue of the bias spring 200, rubbing contact between the outer brake pad 34 and the rotor 15 (i.e., residual brake drag) can be reduced or even eliminated in non-braking conditions (i.e., when the brake is released and/or not applied). In some embodiments, the bias spring 200 has a comparatively high spring stiffness of at least 250 N/mm. In some embodiments, the stiffness of the bias spring 200 is at least 500 N/mm. The stiffness of the bias spring 200 depends on Young's modulus of elasticity and the dimensions of the bias spring 200. Suitable materials for the bias spring 200 include various metals, steel, stainless steel or composite materials.

Typically, the outer brake pads 34 are subject to wear during the lifetime of the brake pads. The wear of the brake pads results in a decreased axial thickness of each brake pad. More specifically, the friction material of the brake pads wears. The bias spring 200, however, should provide a substantially constant retraction force independently from brake pad wear, thereby increasing the friction life of the outer brake pads.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A vehicle disc brake apparatus comprising:
a caliper;
a brake pad carrier coupled to the caliper;
a guide rod extending between the caliper and the brake pad carrier; and
a bias spring surrounding the guide rod, a first end of the bias spring coupled to the caliper and a second opposing end of the bias spring coupled to the carrier, wherein the bias spring is configured to generate a return force between the brake pad carrier and the caliper upon a brake release.

2. The vehicle disc brake apparatus according to claim 1, wherein the bias spring is a tension spring.

3. The vehicle disc brake apparatus according to claim 1, further comprising a retention member provided on the brake pad carrier, wherein the first end of the bias spring is coupled to the retention member.

4. The vehicle disc brake apparatus according to claim 1, wherein the bias spring has a spring body with a first section, a second section, and an intermediate section connecting the first and second sections, the first section being configured to engage the caliper, the second section being configured to engage the brake pad carrier, and the intermediate section extending circumferentially around the guide rod.

5. The vehicle disc brake apparatus according to claim 4, wherein the intermediate section of the bias spring is configured to be extended in an axial direction upon a brake action and configured to return to an unextended state upon a brake release, thereby generating the return force between the brake pad carrier and the caliper.

6. The vehicle disc brake apparatus according to claim 4, wherein the first section of the bias spring is bent to have a first axial extending section and a first lateral extending section and the second section of the bias spring is bent to have a second axial extending section and a second lateral extending section, and wherein the first axial extending section extends along a first axis and the second axial extending section extends along a second axis that is parallel to the first axis.

7. The vehicle disc brake apparatus according to claim 4, wherein the first and second sections of the bias spring are bent to each have a generally U-shape.

8. The vehicle disc brake apparatus according to claim 4, further comprising a retention member provided on the brake pad carrier, wherein the retention member comprises at least one aperture configured to receive an end of the second section of the bias spring, thereby securing the bias spring to the retention member.

9. A vehicle disc brake apparatus comprising:
a housing;
a carrier;
a guide rod extending between the carrier and the housing;
a retention member provided on the carrier; and
a bias spring surrounding the guide rod, a first end of the bias spring coupled to the retention member and a second opposing end of the bias spring engaged with the housing, wherein the bias spring is configured to generate a return force between the carrier and the housing upon a brake release.

10. The vehicle disc brake apparatus according to claim 9, wherein the bias spring is a tension spring.

11. The vehicle disc brake apparatus according to claim 9, wherein the bias spring has a spring body with a housing section, a carrier section, and an intermediate section connecting the housing and carrier sections, the housing section being configured to engage the housing, the carrier section being configured to engage the carrier, and the intermediate section extending circumferentially around the guide rod.

12. The vehicle disc brake apparatus according to claim 11, wherein the intermediate section of the bias spring is configured to be extended in an axial direction upon a brake action and configured to return to an unextended state upon a brake release, thereby generating the return force between the carrier and the housing.

13. The vehicle disc brake apparatus according to claim 11, wherein the housing section of the bias spring is bent to have a first axial extending section and a first lateral extending section and the carrier section of the bias spring is bent to have a second axial extending section and a second lateral extending section, and wherein the first axial extending section extends along a first axis and the second axial extending section extends along a second axis that is parallel to the first axis.

14. The vehicle disc brake apparatus according to claim 11, wherein the housing and carrier sections of the bias spring are bent to each have a generally U-shape.

15. The vehicle disc brake apparatus according to claim 11, wherein the retention member comprises an aperture configured to receive an end of the carrier section of the bias spring, thereby securing the bias spring to the retention member.

16. A bias spring for a brake assembly, the bias spring having a spring body with a first U-shaped section, a second U-shaped section, and an intermediate arcuate section connecting the first U-shaped and section U-shaped sections, wherein:
the first U-shaped section is configured to engage a caliper body of the brake assembly,
the second U-shaped section is configured to engage a brake pad carrier of the brake assembly, and
the intermediate arcuate section extends circumferentially around a guided rod coupled between the caliper body and the brake pad carrier of the brake assembly, the intermediate arcuate section configured to be extended in an axial direction upon a brake action and to return to an unextended state upon a brake release, thereby generating a return force between the caliper body and the brake pad carrier.

17. The bias spring according to claim 16, wherein the first U-shaped section of the bias spring is bent to have a first axial extending section and a first lateral extending section and the second U-shaped section of the bias spring is bent to have a second axial extending section and a second lateral extending section, and wherein the first axial extending section extends along a first axis and the second axial extending section extends along a second axis that is parallel to the first axis.

18. The bias spring according to claim 16, wherein the brake pad carrier has a retention member provided thereon, wherein an end of the second U-shaped section of the bias spring is configured to be received by an aperture in the retention member, thereby securing the bias spring to the retention member.

19. The bias spring according to claim 16, wherein the bias spring is a tension spring.
